(19) United States
(12) Patent Application Publication
(10) Pub. No.: US 2026/0346479 A1
(43) Pub. Date: Nov. 5, 2026

(54) End Effector for an Industrial Robot

(71) Applicant: ABB Schweiz AG, Baden (CH)

(72) Inventors: Xianfeng Deng, Shanghai (CN); Xiaodong Cao, Shanghai (CN); Jonas Haulin, Shanghai (CN); Mao Li, Shanghai (CN); Xinguo Fu, Shanghai (CN)

(21) Appl. No.: 19/712,153

(22) Filed: Jun. 18, 2026

Related U.S. Application Data
(63) Continuation of application No. PCT/CN2024/071619, filed on Jan. 10, 2024.

(51) Int. Cl. B25J 15/04

(52) U.S. Cl. CPC B25J 15/0408

(57) ABSTRACT

An end effector for an industrial robot. It includes an end flange and a carrier assembly fixed to the end flange. The end flange includes an inner side, an outer side, and a through hole, the inner side includes a first connection interface configured to be connected to a manipulator of the industrial robot, the outer side including a second connection interface configured to be connected to a tool. The carrier assembly is fixed to the end flange and configured to carry at least one harness for the tool, wherein the carrier assembly includes an interface plate arranged in the through hole, and the interface plate provides a harnesses interface for the tool.

### TECHNICAL FIELD

Embodiments of the present disclosure generally relate to an industrial robot, and more specifically, to an end effector for the industrial robot with improved harness design.

### BACKGROUND

Industrial robots are widely used in industry fields. An industrial robot typically comprises a manipulator. An end effector may be fixed to a distal end of the manipulator. A tool is further attached to the end effector. In many applications, such as food industrial, pharmaceutical industry, and the like, there is a high hygiene requirement, and the industrial robot should be operated in a “clean room” environment. For example, IP69k protection is required. Harnesses, such as power cables, communication cables, gas conduits, and the like, are required to be within an enclosure of the manipulator. Sealing performances at an interface between the end effector and the tool of the conventional industrial robot is not satisfactory.

### SUMMARY

Example embodiments of the present disclosure provide an end effector and an industrial robot comprising the same which improves space efficiency and sealing performances at an interface between the tool and the end effector.

In a first aspect of the present disclosure, there is provided an end effector for an industrial robot. The end effector comprises: an end flange comprising an inner side, an outer side opposite to the inner side, and a through hole extending axially from the inner side to the outer side, the inner side comprising a first connection interface configured to be connected to a manipulator of the industrial robot, the outer side comprising a second connection interface configured to be connected to a tool, and a carrier assembly fixed to the end flange and configured to carry at least one harness for the tool, wherein the carrier assembly comprises an interface plate arranged in the through hole, and the interface plate provides a harnesses interface for the tool.

Due to the fact that the at least one harness for the tool is carried by the carrier assembly rather than by the end flange, it allows modular arrangement of the harness. The modular design of the end effector improves the compactness and space efficiency and also allows lower manufacturing costs and lower maintenance costs.

In some embodiments, the carrier assembly may further comprise a bundling plate for carrying the interface plate and configured to hold a first length of the at least one harness, and the bundling plate comprises at least one first channel for passage of the at least one harness, the first channel extending axially such that the harnesses arrives at the interface plate perpendicular to an end surface of the interface plate. With this arrangement, the harnesses are not subject to risks of twisting and/or and getting tangled during movement of the manipulator and the service time of the harness thus can be improved.

In some embodiments, the bundling plate may comprise a third connection interface configured to be fixed to the end flange, and the carrier assembly is axially fixed to the end flange at the inner side via the bundling plate.

In some embodiments, the end flange may further comprise a radial flange extending radially from an inner wall surface of the through hole, and the radial flange comprises a first screw hole for receiving a first fastener for axially fixing the bundling plate to the end flange.

In some embodiments, the interface plate may be axially fixed to the bundling plate at the outer side, the bundling plate comprises a second screw hole at the outer side for receiving a second fastener, and the interface plate is connected to the bundling plate via the second fastener.

In some embodiments, the carrier assembly may further comprise: a spacer plate made of an elastic material and configured to hold a second length of the at least one harness, the spacer plate comprising at least one second channel for passage of the at least one harness, and a clamping device circumferentially surrounding the spacer plate and configured to circumferentially compress the spacer plate to at least partially deform the at least one second channel such that the at least one harness is firmly held in the spacer plate. With this arrangement, the risks of twisting and/or getting tangled during movement of the manipulator can be further reduced. Moreover, the harnesses can be firmly held within the end effector.

In some embodiments, the clamping device may comprise: a first half ring part provided on an axial end surface of the bundling plate at the inner side; and a movable second half ring part opposite to the first half ring part, the second half part configured to engage with the first half ring part to form a ring shape for clamping the spacer plate or to detach from the first half ring part to release the at least one harness.

In some embodiments, the first half ring part may comprise two opposite mounting end portions each comprising a first plat portion; the second half ring part comprises two opposite mounting end portions each comprising a second plat portion; and the first half ring part is connected to the second half ring part via a surface contact between the first plat portion and the second plat portion.

In some embodiments, the first plat portion and the second plat portion each may comprise a third screw hole for receiving a third fastener, and the first half ring part is connected to the second half ring part via the third fastener.

In some embodiments, the interface plate may comprise a printed circuit board assembly having a pogo connector, the printed circuit board assembly configured to be connected to, at the inner side, at least one of a cable for powering the tool and a cable for communicating with the tool, and the pogo connector is configured to be connected to, at the outer side, an electrical pins of the tool interface.

In some embodiments, the interface plate may comprise a groove configured to receive the printed circuit board assembly.

In some embodiments, the at least one harness may comprise at least one of a cable for powering, a cable for communication, or an air hose for a hydraulic actuator on the tool.

In some embodiments, the at least one harness may comprise two air hoses, an end of each air hose is provided with a sleeve made of a rigid material, and the air hose is kept in position within the interface plate.

In a second aspect of the present disclosure, there is provided an industrial robot. The industrial robot comprises: a manipulator comprising a sealing enclosure; at least one harness extending within the sealing enclosure; and an end effector according to any of the first aspect connected to the manipulator of the industrial robot and configured to provide a harnesses interface for the at least one harness.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a perspective view of an industrial robot according to one example embodiment of the present disclosure;

FIG. 2 is an axial perspective overall view of an end effector according to one example embodiment of the present disclosure as seen from an outer side;

FIG. 3 is an exploded perspective view of the end effector according to one example embodiment of the present disclosure as seen from an inner side;

FIG. 4 is an axial sectional view of the end effector according to one example embodiment of the present disclosure;

FIG. 5 is an exploded perspective view of a carrier assembly of the end effector according to one example embodiment of the present disclosure as seen from the inner side; and

FIG. 6 is an exploded perspective view of the carrier assembly of the end effector according to one example embodiment of the present disclosure as seen from the outer side.

Throughout the drawings, the same or similar reference symbols are used to indicate the same or similar elements.

### DETAILED DESCRIPTION

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

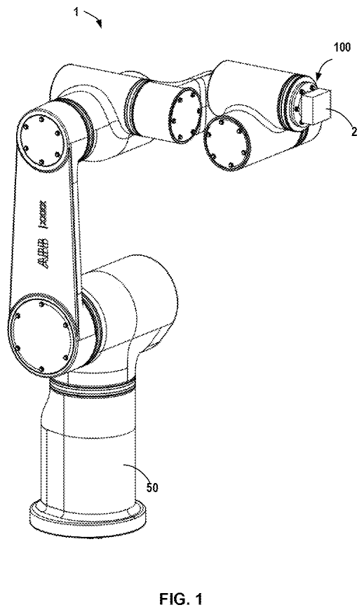

FIG. 1 is an overall view of an industrial robot 100 according to one example embodiment of the present disclosure. As shown in FIG. 1, the industrial robot 1 is a multi-axis robot and comprises a manipulator connected to a base 50. The base 50 may be fixed or mobile. The manipulator is formed by a plurality of joints and a plurality of structural arms connecting the adjacent joints. Each joint includes one or more actuators including, for example, a motor, a gearbox, a sensor, and the like. An end effector 100 is provided at a distal end (in the example shown, a wrist joint) of the manipulator. A tool 2 designed for performing various tasks is further fixed to the end effector 100. By controlling the manipulator, the tool 2 is moved in a workspace so as to do various industrial tasks.

In addition to the actuators in the joints, the tool 2 also needs one or more harnesses, such as cables for powering, cables for communication, air pipes for a hydraulic actuator. For example, electric actuators may be provided on the tool 2 and are used for controlling a posture or movement of a tool component. A cable for powering is needed so as to power the electric actuators on the tool. In some embodiments, a sensor for capturing data of the tool or a surrounding may be provided on the tool. A cable for communication is needed so as to transmit the data from and/to a controller of the industrial robot. In some embodiments, a hydraulic actuator may be provided on the tool. An air pipe connected to a compressor; an air source is needed so as to transmit air from and to the hydraulic actuator.

Typically, to meet “clean room” requirements, these harnesses should be arranged within an enclosure of the industrial robot and are prevented from exposing to the environment. These harnesses typically include a plastic coating. When the manipulator moves around in the workspace, the harnesses may generate particles due to friction. These particles may be detrimental to the environment, which does not meet “clean room” requirements. Also, these harnesses may be of different lengths and may be arranged at different positions of the manipulator. If these harnesses are not properly fixed, there is a risk that the harnesses may twist and get tangled, which may cause damage to the robot. Accordingly, the harnesses at an interface between the end effector and the tool should be properly arranged to prevent any harness from being exposed to the environment.

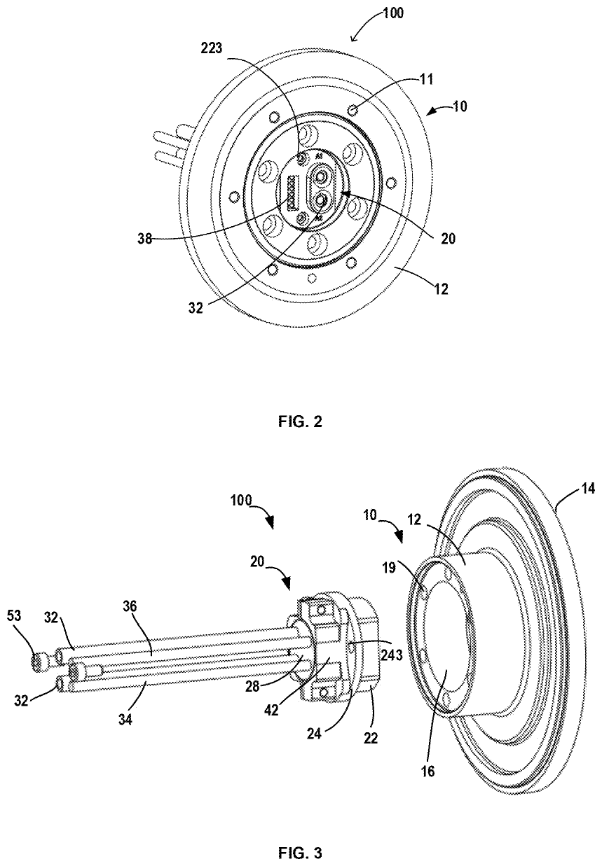

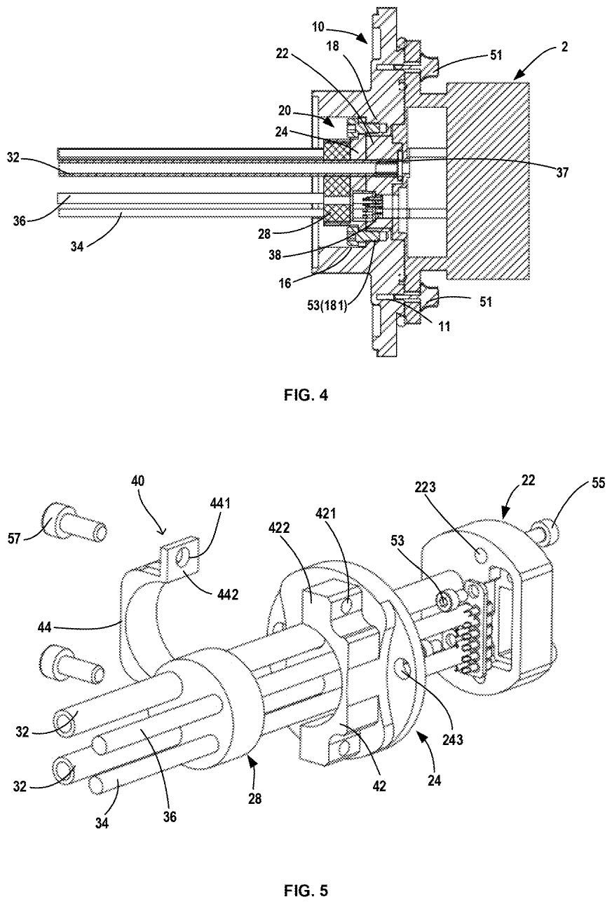

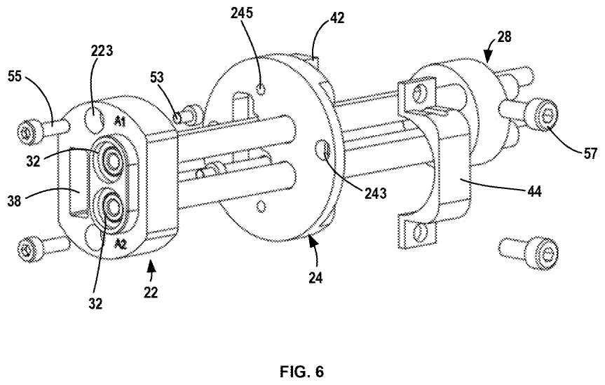

FIGS. 2-6 show an end effector according to one example embodiment of the present disclosure. FIGS. 2 and 3 show axial perspective overall view of an end effector according to one example embodiment of the present disclosure. FIG. 4 shows an axial sectional view of the end effector. FIGS. 5 and 6 show an exploded perspective view of a carrier assembly of the end effector.

As shown in FIGS. 2-4, the end effector 100 comprises an end flange 10 and a carrier assembly 20 fixed to the end flange 10. The end flange 10 is used for supporting the tool 2. The carrier assembly 20 is configured to support and bundle the harnesses 32, 34, 36. The end flange 10 includes an inner side 12, an outer side 14 opposite to the inner side 12, and a through hole 16. The inner side 12 is located at an inner portion of the manipulator (for example, the enclosure of the manipulator) and is substantially of a shape of flange. The inner side 12 may include a flange as a connection interface. The flange may include one or more screw holes 19. In some embodiments, the end flange may be a part of a wrist joint. The wrist joint may include an actuator including a fixed part and a movable part driven by a motor, and the end flange may be fixed to the movable part of the actuator. Thus, the end flange 10 is ratable with respect to the distal end of the manipulator. The outer side 14 is exposed to the user and is accessible for the user. Various interfaces for connecting to the tool, such as an electrical connection interface, a hard-wired communication interface, an air hose, and the like, are exposed at the outer side 14. The outer side 14 may include one or more screw holes 11 as a connection interface (referring to FIGS. 2 and 4). The tool 2 may be fixed to the end flange 10 by threading fasteners 51 into the screw holes 11. The through hole 16 axially penetrates through the end flange 10. The through hole 16 provides room for modular mounting of the carrier assembly 20 and also allows the harness connection interfaces to be exposed to the user from the outer side 14.

As shown in FIGS. 2-4, the carrier assembly 20 is configured to carry one or more harnesses 32, 34, 36. The harnesses 32, 34, 36 are fixed to the carrier assembly 20 rather than to the end flange 10. The carrier assembly 20 thus is used as a harness bundler. After the harnesses 32, 34, 36 being fixed to the carrier assembly 20, the carrier assembly 20 is then fixed to the end flange 10. In the example shown, the harnesses 32, 34, 36 comprises a cable 36 for powering the tool 2, a cable 34 for communication, and two air hoses 32 for a hydraulic actuator on the tool 2. It is to be understood that the number of the harnesses 32, 34, 36 is merely illustrative and the number of the harnesses 32, 34, 36 may be any other proper number.

The carrier assembly 20 comprises an interface plate 22 arranged in the through hole 16, and the interface plate 22 provides harnesses interfaces for the tool 2. As shown in FIG. 2, various harness interfaces of the harnesses 32, 34, 36 can be exposed to the user on the outer side of the interface plate 22. The power lines, the communication lines, or hydraulic the actuator on the tool can be easily connected to the harnesses 32, 34, 36. By use of the interface plate, the harnesses can be implemented in a modular form. It is easy to assembly the end effector. Also, when parts on the carrier assembly 20 fail, the carrier assembly can be easily replaced without replacing the whole end effector, which results in low maintenance cost. The carrier assembly 20 also provides advantages in terms of space efficiency. Typically, the space on the end flange 10 is precious. By integrating various harness connection interfaces into the interface plate 22 which is placed in the through hole 16, various harness connection interfaces can be arranged in a space efficacy way.

In some embodiments, as shown in FIGS. 1, 3, and 4, the interface plate 22 may include a printed circuit board assembly 38. On the inner side, the printed circuit board assembly 38 may be connected, for example, by soldering, to the cable 36 for powering the tool 2 and/or the cable 34 for communication. On the outer side, the printed circuit board assembly 38 may include a pogo connector. A pin connector on the tool 2 may be connected to the pogo connector directly, for example, by press fit. In some embodiments, as shown in FIG. 4, a groove may be provided in the interface plate 22 and the printed circuit board assembly 38 may be provided within the groove. This may reduce the thickness of the end effector.

In some embodiments, as shown in FIGS. 1 and 4, the interface plate 22 may include one or more channels for passage of the harnesses, for example, the two air hoses 32. The distal ends of the two air hoses 32 may end at the outer side of the interface plate 22. Pipe connector from a hydraulic actuator on the tool 2 may be directly connected to the distal ends of the two air hoses 32. In some embodiments, the distal ends of the two air hoses 32 may also be with a sleeve 37 made of a rigid material. The rigid sleeve prevents shrinkage of the air hoses and allows easy connection to the pipe connector from a hydraulic actuator on the tool 2. This is advantageous in the case that the air hose 32 is made of flexible material. When the air hose 32 is made of rigid material, the sleeve 37 may be omitted.

In some embodiments, as shown in FIGS. 3-6, the carrier assembly 20 may further comprise a bundling plate 24 for carrying the interface plate 22 and configured to hold a length of the harnesses 32, 34, 36. The bundling plate 24 may include one or more channels for passage of the harnesses 32, 34, 36. The channels extend axially such that the harnesses arrive at the interface plate 22 perpendicular to an end surface of the interface plate 22. The channels on the bundling plate 24 may align with the holes on the interface plate 22. As known, the harnesses 32, 34, and 36 are typically made of flexible material. During movement of the manipulator, there is a risk that the harnesses may twist and get tangled. By provision of the bundling plate 24, orientation of the harnesses and a distance among different harnesses can be kept stable, the twisting risk of the harnesses is reduced.

In some embodiments, as shown in FIGS. 1 and 6, the interface plate 22 may be axially fixed to the bundling plate 24 at the outer side 14. The bundling plate 24 may comprise a screw hole 245 for receiving a fastener 55. The interface plate 22 may include a through hole 223. The fastener 55 may pass through the through hole 223 and is threaded into the screw hole 245 to fix the interface plate 22 to the bundling plate 24.

In some embodiments, the bundling plate 24 may also serve as means for fixing the carrier assembly 20 to the end flange 10. As shown in FIGS. 3, 4, and 5, the end flange 10 further comprises a radial flange 18. The radial flange 18 extends radially from an inner wall surface of the through hole 16. The radial flange 18 may include a screw hole 181 for receiving a fastener 53. The bundling plate 24 may include a through hole 243. The fastener 53 may pass through the through hole 243 and is threaded into the screw hole 181 to fix bundling plate 24 to the end flange 10.

In some embodiments, as shown in FIGS. 3-6, the carrier assembly 20 may further comprise a spacer plate 28 and a clamping device 40. The spacer plate 28 may be configured to hold a length of the harnesses 32, 34, 36. The spacer plate 28 may include one or more channels for passage of the harnesses 32, 34, 36. The clamping device 40 circumferentially surrounds the spacer plate 28. In the example shown, the spacer plate 28 is a circular shape. It is to be understood that the spacer plate may be of any other proper shapes. The clamping device 40 is configured to compress the spacer plate 28 to firmly hold the harnesses 32, 34, 36. The spacer plate 28 may be made of an elastic material. Through compression by the clamping device 40, the spacer plate 28 is configured to be deformed such that the harnesses 32, 34, 36 are firmly held in the channels within the spacer plate 28. By provision of the spacer plate 28, the twisting risk of the harnesses can be further reduced. Also, the harnesses 32, 34, 36 can kept stationary with respect to the carrier assembly 20.

The clamping device 40 may be of various forms. In some embodiments, the clamping device 40 may be in form of a hooping device. As shown in FIGS. 5 and 6, the clamping device 40 may include a first half ring part 42 and a movable second half ring part 44. The first half ring part 42 may be provided on an axial end surface of the bundling plate 24. The second half ring part 44 is movable to the first half ring part 42. In particular, the second half ring part 44 may get closer to the first half ring part 42 and engages with the first half ring part 42 to form a hoop. The spacer plate 28 may be arranged within the hoop and is deformed by the clamping forces from the two half ring parts 42, 44. The second half ring part 44 may be separate from the first half ring part 42 to release the spacer plate 28. When the spacer plate 28 is released, the harnesses 32, 34, 36 are movable, for example by pulling force.

In some embodiments, as shown in FIGS. 5 and 6, the first half ring part 42 may comprise two opposite mounting end portions. At each mounting end portion, a first plat portion 422 is provided. Likewise, the second half ring part 44 may comprise two opposite mounting end portions. At each mounting end portion, a second plat portion 442 is provided. The first half ring part 42 is connected to the second half ring part 44 via a surface contact between the first plat portion 422 and the second plat portion 442.

In some embodiments, the first plat portion 422 and the second plat portion 442 each comprise a screw hole 421, 441. The first half ring part 42 is connected to the second half ring part 44 via the third fastener 57. By using this arrangement, the force for clamping the spacer plate 28 can be adjusted.

It is to be understood that in the shown example the tool 2 is described as a component distinct from the end effector 100, this is merely for illustration purpose and the tool 2 may be formed as part of the end effector 100. In the latter case, the tool 2 and the end flange 10 of the joint and the carrier assembly 20 may be collectively called as an end effector 100.

According to the present disclosure, the harnesses, besides the interface portions, are completely arranged within the end effector. This fulfills the clean room requirements for the industrial robots, in particular, it can achieve IP69k level. In addition, due to the specific structure of the harness carrier assembly, the harnesses are not subject to risks of twisting and/or getting tangled during movement of the manipulator and the service time of the harness thus can be improved. The modular design of the end effector improves the compactness and space efficiency and also allows lower manufacturing costs and lower maintenance costs.

The description of the various embodiments of the present invention has been presented for purposes of illustration but is not intended to be exhaustive or limited to the embodiments disclosed. Many modifications and variations will be apparent to those of ordinary skill in the art without departing from the scope and spirit of the embodiments described. The terminology used herein was chosen to best explain the principles of the embodiments, the practical application or technical improvement over technologies found in the marketplace, or to enable others of ordinary skill in the art to understand the embodiments disclosed herein.

1. An end effector for an industrial robot, comprising:
an end flange including an inner side, an outer side opposite to the inner side, and a through hole extending axially from the inner side to the outer side, the inner side including a first connection interface configured to be connected to a manipulator of the industrial robot, the outer side including a second connection interface configured to be connected to a tool, and
a carrier assembly fixed to the end flange and configured to carry at least one harness for the tool, wherein the carrier assembly includes an interface plate arranged in the through hole, and the interface plate provides a harnesses interface for the tool.

2. The end effector of claim 1, wherein the carrier assembly further comprises a bundling plate for carrying the interface plate and configured to hold a first length of the at least one harness, and
the bundling plate includes at least one first channel for passage of the at least one harness, the first channel extending axially such that the harnesses arrive at the interface plate perpendicular to an end surface of the interface plate.

3. The end effector of claim 2, wherein the bundling plate comprises a third connection interface configured to be fixed to the end flange, and the carrier assembly is axially fixed to the end flange at the inner side via the bundling plate.

4. The end effector of claim 2, wherein the end flange further comprises a radial flange extending radially from an inner wall surface of the through hole, and
the radial flange includes a first screw hole for receiving a first fastener for axially fixing the bundling plate to the end flange.

5. The end effector of claim 2, wherein the interface plate is axially fixed to the bundling plate at the outer side, the bundling plate comprises a second screw hole at the outer side for receiving a second fastener, and the interface plate is connected to the bundling plate via the second fastener.

6. The end effector of claim 2, wherein the carrier assembly further comprises:
a spacer plate made of an elastic material and configured to hold a second length of the at least one harness, the spacer plate including at least one second channel for passage of the at least one harness, and
a clamping device circumferentially surrounding the spacer plate and configured to circumferentially compress the spacer plate to at least partially deform the at least one second channel such that the at least one harness is firmly held in the spacer plate.

7. The end effector of claim 6, wherein the clamping device comprises:
a first half ring part provided on an axial end surface of the bundling plate at the inner side; and
a movable second half ring part opposite to the first half ring part, the second half part configured to engage with the first half ring part to form a ring shape for clamping the spacer plate or to detach from the first half ring part to release the at least one harness.

8. The end effector of claim 7, wherein the first half ring part comprises two opposite-mounting end portions each comprising a first plat portion;
the second half ring part includes two opposite mounting end portions each including a second plat portion; and
the first half ring part is connected to the second half ring part via a surface contact between the first plat portion and the second plat portion.

9. The end effector of claim 8, wherein the first plat portion and the second plat portion each comprise a third screw hole for receiving a third fastener, and the first half ring part is connected to the second half ring part via the third fastener.

10. The end effector of claim 1, wherein the interface plate comprises a printed circuit board assembly having a pogo connector, the printed circuit board assembly configured to be connected to, at the inner side, at least one of a cable for powering the tool and a cable for communicating with the tool, and the pogo connector is configured to be connected to, at the outer side, an electrical pins of the tool interface.

11. The end effector of claim 10, wherein the interface plate comprises a groove configured to receive the printed circuit board assembly.

12. The end effector of claim 1, wherein the at least one harness comprises at least one of a cable for powering, a cable for communication, or an air hose for a hydraulic actuator on the tool.

13. The end effector of claim 1, wherein the at least one harness comprises two air hoses, an end of each air hose is provided with a sleeve made of a rigid material, and the air hose is kept in position within the interface plate.

14. An industrial robot, comprising:
a manipulator comprising a sealing enclosure;
at least one harness extending within the sealing enclosure; and
an end effector including:
an end flange including an inner side, an outer side opposite to the inner side, and a through hole extending axially from the inner side to the outer side, the inner side including a first connection interface configured to be connected to a manipulator of the industrial robot, the outer side including a second connection interface configured to be connected to a tool, and
a carrier assembly fixed to the end flange and configured to carry at least one harness for the tool, wherein the carrier assembly includes an interface plate arranged in the through hole, and the interface plate provides a harnesses interface for the tool connected to the manipulator of the industrial robot and configured to provide a harnesses interface for the at least one harness.

15. The end effector of claim 2, wherein the interface plate comprises a printed circuit board assembly having a pogo connector, the printed circuit board assembly configured to be connected to, at the inner side, at least one of a cable for powering the tool and a cable for communicating with the tool, and the pogo connector is configured to be connected to, at the outer side, an electrical pins of the tool interface.

16. The end effector of claim 2, wherein the at least one harness comprises at least one of a cable for powering, a cable for communication, or an air hose for a hydraulic actuator on the tool.

17. The end effector of claim 2, wherein the at least one harness comprises two air hoses, an end of each air hose is provided with a sleeve made of a rigid material, and the air hose is kept in position within the interface plate.

18. The end effector of claim 3, wherein the interface plate is axially fixed to the bundling plate at the outer side, the bundling plate comprises a second screw hole at the outer side for receiving a second fastener, and the interface plate is connected to the bundling plate via the second fastener.

19. The end effector of claim 3, wherein the carrier assembly further comprises:
a spacer plate made of an elastic material and configured to hold a second length of the at least one harness, the spacer plate including at least one second channel for passage of the at least one harness, and
a clamping device circumferentially surrounding the spacer plate and configured to circumferentially compress the spacer plate to at least partially deform the at least one second channel such that the at least one harness is firmly held in the spacer plate.
